(19) United States
(12) Patent Application Publication
(10) Pub. No.: US 2004/0186749 A1
(43) Pub. Date: Sep. 23, 2004

(54) Insurance information verification system

(76) Inventor: Desmond Ezenwa Iwuagwu, Grapevine, TX (US)

Correspondence Address: DESMOND IWUAGWU, APT. 125, 2701 N. GRAPEVINE MIUS BLVD., GRAPEVINE, TX, 76051, US

(21) Appl. No.: 10/390,899

(22) Filed: Mar. 19, 2003

(51) Int. Cl. G06F 17/60; G06F 7/00; G06F 17/00

(52) U.S. Cl. 705/4; 707/104.1

(57) ABSTRACT

A website linked to a proprietary database. This database is unique in that it is updated directly with specific information provided by the insurance companies on an hourly, daily or other mentioned schedule. The specific information provided will allow the immediate, effective, and cost efficient access to any auto insurance policy information to confirm if they are active or not, by verifying that policy through the combination of the following parameters:

1: Name of policy holder

2: Name of insurance company

3: Insurance policy number

4: Insurance policy status, e.g.: cancelled, terminated, or active.

### FIELD OF THE INVENTION

The present invention relates to a proprietary system of insurance policy verification, more particularly, to insurance policy verification within the united states over a network, through the Internet, using data provided by the insurance companies through a proprietary network database system.

### BACKGROUND OF THE INVENTION

Ever since auto insurance has been available there has been a need to verify them for accuracy by law enforcement. This is because the law requires automobiles to be insured. The current method of verification involves simply reading the insurance card or policy as it was originally written by the insurance company, and this creates a problem in that it allows the loophole for driving without insurance because it isn't always accurate in that people sometimes drive with cancelled policies, knowing that the insurance card they have reflect that they have insurance even though they may not. This problem currently encourages people to brake the federal law requiring all automobiles to be adequately insured.

currently the only other solution has been calling the insurance company directly to confirm if the policy is accurate.

Calling the insurance company directly has not always been effective because of several reasons that include;

1) Not all law enforcement officers have access to a means of contacting the insurance companies (I.e. Cell phones)

2) Even with a cell phone, the time involved in getting in touch with the proper personnel to confirm the status of a policy sometimes proves overwhelming extensive, prolonging the contact needlessly, and serving to sometimes escalate the interaction.

It is therefore an object of the invention to provide legal access to a database of insurance policy information through an online network using proprietary software.

It is another object of the invention to verify the name of the policy holder of an insurance policy

It is another object of the invention to verify the insurance company associated with the policy number.

It is another object of the invention to establish the status of any automobile insurance policy

### SUMMARY OF THE INVENTION

In accordance with the present invention, there is provided a website linked to a proprietary database. This database is unique in that it is updated directly with specific information provided by the insurance companies on an hourly, daily or other mentioned schedule. The specific information provided will allow the immediate, effective, and cost efficient access to any auto insurance policy information to confirm if they are active or not, by verifying that policy through the combination of the following parameters:

1: Name of policy holder

2: Name of insurance company

3: Insurance policy number

4: Insurance policy status, e.g.: cancelled, terminated, or active.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a.

For purposes of clarity and brevity, like elements and components will bear the same designations and numbering throughout the FIGURES.

### DESCRIPTION OF THE PREFERRED EMBODIMENT

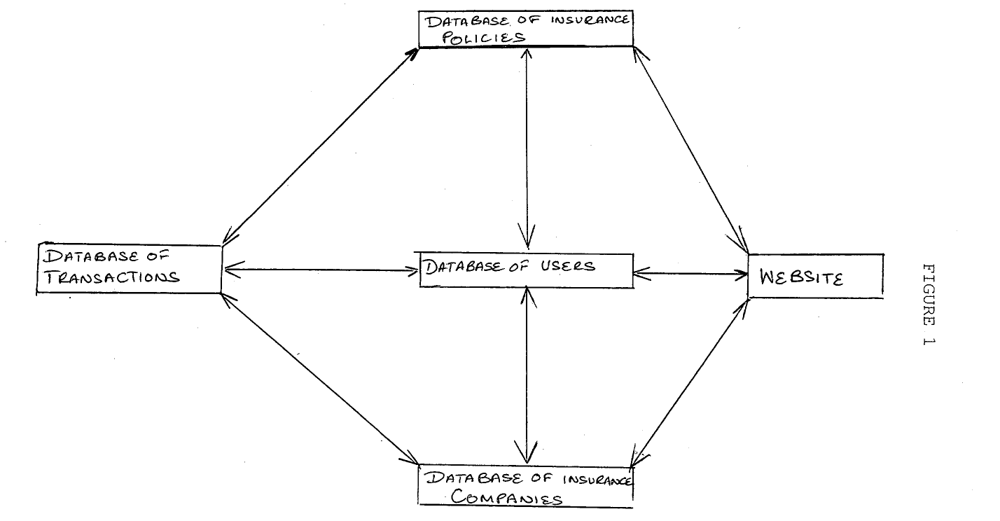

FIG. 1 is a perspective view of a.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An insurance information verification system for access to any insurance company's policy to confirm if that policy is active, valid or cancelled comprising:
means for access to the ceceron database of auto insurance policy information and verification services;
means for maintaining a legal database of specific information for auto insurance policies directly updated by insurance companies and/or using the specific information provided by the insurance companies, functionally connected to said means for access to the ceceron database of auto insurance policy information and verification services;
means for maintain a database of all insurance companies providing auto insurance policy information and updates to the ceceron database for verification, directly linked to said means for access to the ceceron database of auto insurance policy information and verification services;
means for maintain a database of users granted access to the ceceron auto insurance policy verification services. this includes the user name, password, profile and history, operationally connected to said means for maintain a database of all insurance companies providing auto insurance policy information and updates to the ceceron database for verification, operationally connected to said means for maintaining a legal database of specific information for auto insurance policies directly updated by insurance companies and/or using the specific information provided by the insurance companies, and directly linked to said means for access to the ceceron database of auto insurance policy information and verification services; and
means for maintainng a database of auto insurance policy information verification request's by all ceceron's users that includes the time and date of such request's, along with the specific insurance policy verified, and that policy's associated insurance company, securely connected to said means for maintain a database of users granted access to the ceceron auto insurance policy verification services. this includes the user name, password, profile and history, securely connected to said means for maintain a database of all insurance companies providing auto insurance policy information and updates to the ceceron database for verification, and securely connected to said means for maintaining a legal database of specific information for auto insurance policies directly updated by insurance companies and/or using the specific information provided by the insurance companies.

2. The insurance information verification system in accordance with claim 1, wherein said means for access to the ceceron database of auto insurance policy information and verification services. comprises a website.

3. The insurance information verification system in accordance with claim 1, wherein said means for maintaining a legal database of specific information for auto insurance policies directly updated by insurance companies and/or using the specific information provided by the insurance companies. comprises a datatbase of insurance policies.

4. The insurance information verification system in accordance with claim 1, wherein said means for maintain a database of all insurance companies providing auto insurance policy information and updates to the ceceron database for verification. comprises a database of insurance companies.

5. The insurance information verification system in accordance with claim 1, wherein said means for maintain a database of users granted access to the ceceron auto insurance policy verification services. this includes the user name, password, profile and history comprises a database of users.

6. The insurance information verification system in accordance with claim 1, wherein said means for maintainng a database of auto insurance policy information verification request's by all ceceron's users that includes the time and date of such request's, along with the specific insurance policy verified, and that policy's associated insurance company. comprises a database of transaction.

7. An insurance information verification system for access to any insurance company's policy to confirm if that policy is active, valid or cancelled comprising:
a website, for access to the ceceron database of auto insurance policy information and verification services;
a datatbase of insurance policies, for maintaining a legal database of specific information for auto insurance policies directly updated by insurance companies and/or using the specific information provided by the insurance companies, functionally connected to said Website;
a database of insurance companies, for maintain a database of all insurance companies providing auto insurance policy information and updates to the ceceron database for verification, directly linked to said Website;
a database of users, for maintain a database of users granted access to the ceceron auto insurance policy verification services. this includes the user name, password, profile and history, operationally connected to said Database of Insurance companies, operationally connected to said Datatbase of Insurance policies, and directly linked to said Website; and
a database of transaction, for maintainng a database of auto insurance policy information verification request's by all ceceron's users that includes the time and date of such request's, along with the specific insurance policy verified, and that policy's associated insurance company, securely connected to said Database of users, securely connected to said Database of Insurance companies, and securely connected to said Datatbase of Insurance policies.

8. An insurance information verification system for access to any insurance company's policy to confirm if that policy is active, valid or cancelled comprising:
a website, for access to the ceceron database of auto insurance policy information and verification services;
a datatbase of insurance policies, for maintaining a legal database of specific information for auto insurance policies directly updated by insurance companies and/or using the specific information provided by the insurance companies, functionally connected to said Website;
a database of insurance companies, for maintain a database of all insurance companies providing auto insurance policy information and updates to the ceceron database for verification, directly linked to said Website;
a database of users, for maintain a database of users granted access to the ceceron auto insurance policy verification services. this includes the user name, password, profile and history, operationally connected to said Database of Insurance companies, operationally connected to said Datatbase of Insurance policies, and directly linked to said Website; and
a database of transaction, for maintainng a database of auto insurance policy information verification request's by all ceceron's users that includes the time and date of such request's, along with the specific insurance policy verified, and that policy's associated insurance company, securely connected to said Database of users, securely connected to said Database of Insurance companies, and securely connected to said Datatbase of Insurance policies.
